(19) United States
(12) Patent Application Publication
(10) Pub. No.: US 2005/0149387 A1
(43) Pub. Date: Jul. 7, 2005

(54) RFID system and method for instant rebates

(75) Inventors: Michael D. O'Shea, Neenah, WI (US); Richard Polzin, Neenah, WI (US); Ivan B. Schrodt, Sherwood, WI (US); Patrick J. Clusman, Neenah, WI (US)

Correspondence Address: DORITY & MANNING, P.A., POST OFFICE BOX 1449, GREENVILLE, SC, 29602-1449, US

(73) Assignee: KIMBERLY-CLARK WORLDWIDE, INC.

(21) Appl. No.: 10/748,118

(22) Filed: Dec. 30, 2003

(51) Int. Cl. G06F 17/60

(52) U.S. Cl. 705/14

(57) ABSTRACT

A method and system for electronically processing and redeeming rebate offers is disclosed. RFID smart tags are associated with products where each distinct product is associated with at least one smart tag. The smart tags contain product information including product identification information and/or rebate related information. The disclosed method and system allows for a rebate redemption and processing system that (1) more fully automates the rebate process by minimizing or eliminating the need for a customer to perform any task to initiate the rebate redemption process after leaving a point of sale, (2) provides the ability for manufacturers to offer real-time (or near real-time) rebate offers, (3) eliminates the need for a rebate check and (4) provides the customer with some level of instant gratification related to the purchase price of the product.

### TECHNICAL FIELD OF THE INVENTION

The present invention relates to an apparatus and method for redeeming and processing product marketing rebates using radio frequency identification system proof-of-purchase technology.

### BACKGROUND

Supply Chain Management (SCM) is a common problem for any organization involved in the design, manufacture and distribution of goods. SCM is particularly important in retail organizations where the successful management of product inventory and the promotion of consumer satisfaction are essential for efficient operation, consumer loyalty, and optimal profit margins. Common SCM activities for product manufacturers as well as retailers include inventory control, supplier network development, purchasing and marketing.

One well known marketing tool is to provide customers with purchasing incentives, such as rebates. Prior art rebate systems, however, typically require a retailer to manually track a manufacturer's promotions for a particular product and provide the appropriate rebate information and forms to customers. In addition, with such prior art systems, the following events must typically occur to achieve a successful rebate transaction: (1) a customer must retain sales documents, (2) a customer must obtain and fill out rebate forms, (3) a customer must supply proof-of-purchase, typically from the product packaging, (4) a customer must enclose such information in a correctly addressed envelope with the appropriate postage and mail the entire rebate package to the product manufacturer or a third party rebate processing entity, (5) the product manufacturer or third party must receive and correctly process the rebate information, (6) the product manufacturer or third party must mail the rebate check to the correct customer address and the rebate check must be delivered to the correct customer address, and (7) the customer must keep track of such rebate check until the customer makes a trip, often a special trip, to his/her financial institution to deposit such rebate check into his/her account.

Such prior art rebate systems place both inconveniences and costs on retailers and customers and are unnecessarily inflexible in today's electronic world. First, such prior art systems do not allow for real-time (or near real time) rebate offers making such rebate programs slow in responding to customer shopping trends. Second, manufacturers must bare the administrative costs associated with manually processing rebate redemption paperwork and such costs reduce the amount of rebate a manufacturer can offer. Third, customers must invest their time and money to assemble and mail such paperwork and wait weeks for the rebate to process. Many customers today desire and expect instant gratification (i.e. an “instant” rebate or e-bate) and the relatively long time between making a purchase and seeing a rebate check coupled with the previously described burdensome rebate related tasks often result in all but the most frugal of customers ignoring rebate offers. Such processing related inconveniences and costs greatly reduce the effectiveness of rebate offers.

Recently developed electronic rebate processing improvements minimize many of the above noted issues with older paper intensive prior art rebate systems. One such method, apparatus and article of manufacturer for processing rebates is disclosed by Kepros et al. in U.S. application Ser. No. 09/835,731 (Pub. No. U.S. 2002/0152119 A1), filed Apr. 16, 2001 and such application is hereby incorporated by reference for all purposes. However, such prior art systems still require a user or customer to access a computer system and supply additional information (days or even weeks after the purchasing event, depending on the diligence of the customer) to complete the rebate process. Such prior art systems also require a customer to wait for a rebate check and manually cash such check or deposit such check into the customer's bank account. Finally, such prior art systems do not provide a manufacturer with the ability to offer real-time, or near real time, rebate offers.

Therefore, a need exists for a rebate redemption and processing system that (1) more fully automates the rebate process by minimizing or eliminating the need for the customer to perform any task to initiate the rebate redemption process after leaving a point of sale, (2) that provides the ability for manufacturers to offer real-time (or near real-time) rebate offers, (3) that eliminates the rebate check, and (4) provides the customer with some level of instant gratification.

### SUMMARY

Objects and advantages of the invention will be set forth in the following description, or may be obvious from the description, or may be learned through practice of the invention.

One embodiment of the present invention relates generally to novel implementations of Radio Frequency Identification Device (RFID) technology to assist organizations with various aspects of providing an almost paperless electronic based rebate processing system. Such an RFID rebate system provides an opportunity for manufactures to issue real-time rebate offers as well as process a rebate claim at the time of purchase with little or no customer action required after leaving the point of sale. Thus, a properly designed rebate system according to aspects of the present invention will provide significant improvements in rebate programs by lowering administrative costs, providing real-time rebate offers, minimizing the burdens placed on customers to initiate a rebate claim, and will provide greater level of instant gratification to the customer at the point of sale.

Radio Frequency Identification Devices and associated systems are well suited for SCM applications in general and rebate systems in particular. RFID systems may include low-cost, passive “smart” chips or “tags” that can be embedded in or attached to articles, products, and the like to convey information about the product via a scanner. Smart tags are generally small label-like devices with a micro-chip and a miniature embedded antenna. Such tags may be passive or active, the active tags requiring an internal power supply. A reader or scanner interrogates the smart tag with an electronic “trigger” signal. The smart tag in turn generates an electromagnetic pulse response that is readable by the scanner, the response containing the product information. RFID smart tags can be associated with a product by being embedded in or attached to product packaging, or incorporated directly into the product, and may convey conventional “bar code” information, as well as other more detailed information.

In one exemplary embodiment of an electronic rebate system according to the present invention, at least one electronic tag device, such as an RFID tag, is associated with a product. Such RFID tag stores product information which may include rebate identification information. A first central computer is configured to use an electronic reading device (such as an RFID Smart Tag Reader) to retrieve at least some of the information stored in the electronic tag. The first central computer may then determine rebate claim information requirements for the product being purchased. For example, if the retrieved product information includes a product identification code, the first central computer may use such code to access a database containing rebate claim requirements for the product associated with such product identification code. The first computer may then generate or accumulate the required rebate claim information, such as purchase date, purchase price, purchase location and customer name, address, phone number as well as other related information. The first central computer is further configured to communicate with a second central computer(s). Such second central computer may be a manufacturer central computer or a third party central computer that executes and/or oversees the rebate claim redemption process. The first central computer initiates a transfer of the rebate claim information to the second central computer. The second central computer then initiates the rebate processing system that processes the rebate claim and sends rebate status information back to the first central computer. The first central computer may then initiate generation of rebate documentation depicting the rebate status, where such rebate documentation is given to the customer at the point of sale and/or e-mailed to a predefined e-mail address. Such rebate status information may also be printed on a receipt that is given to the customer. For example, the rebate status report may simply state that the rebate claim has been approved and an Electronic Fund Transfer (EFT) has been initiated.

The above exemplary embodiment may also include a customer interface. The customer interface may have a LCD screen and is in communication with the first central computer and/or the RFID STR devices. Such an exemplary embodiment provides the ability for a manufacturer to monitor real-time customer shopping activity via a connection with the first central computer in the retailer establishment, generate a customer generic or customer specific rebate offer and present such rebate offer to a customer in real-time via the customer interface.

Another embodiment of the present technology relates to an apparatus for processing an electronic rebate claim. In this embodiment, a first central computer (preferably a manufacturer central computer) is configured to receive rebate-claim-information from a remote computer (i.e., a retailer central computer). Such first central computer evaluates the validity of the rebate claim using at least part of the received rebate-claim-information and transmits rebate-claim-status-information to a computing device at a point of sale. Such computing device may be the remote computer or a portable digital device, such as a personal digital assistant (PDA), in wireless communication with either the first central computer or the remote computer via wireless technology, such as Wireless Fidelity (Wi-Fi) or Bluetooth.

The first central computer may also initiate an electronic fund transfer, such as an automated clearing house (ACH) transfer, to a predefined bank account. Such electronic fund transfer would typically be in the amount of the rebate and would transfer money from the manufacturer's account into the customer's account.

Another aspect of the invention relates to methodology for making a rebate claim. A methodology according to the one embodiment of the present invention involves, in general aspects, RFID smart tags used in combination with a process for electronically making rebate claims. Such a method provides the ability to obtain, at the point of sale, the majority, if not all, of the rebate related information required to process a rebate claim. The disclosed methodology may be used, for example, in a supply chain that includes a manufacturer computer and associated database and a retailer computer and associate database. The smart tags may be associated with a product at the manufacturing facility and coded with product information, such as the name of the product, type or category of product, a product identification code and so forth. RFID Smart Tag Readers (STR) may be made available at various points along the supply chain in a number of conceivable scenarios according to the invention. One location in particular where such RFID STR devices may be provided is at a point of sale. The RFID STR devices may be configured to use various techniques, as described in more detail later, for retrieving the product information stored in an RFID smart tag. The RFID STR devices may then transfer such information to another electronic device, such as a computer.

In one particular embodiment of the system and methodology according to the invention, the smart tags are associated with each distinct product, ideally at the place of manufacture. The smart tags may be in the form of adhesive labels or the like that are attached directly to the product packaging, or to a separate container that holds the product. Such RFID tagged products are typically placed in customer display inventory locations at the retailer store. Exemplary customer display inventory locations include store shelves, refrigeration units, store cabinets, etc., wherever products are located for customer viewing. RFID tagged products may also be placed in retailer storage inventory locations. One well known exemplary retailer storage inventory location is the in-store stock room. For Internet based retailers, most, if not all of the products will be located in a retailer storage inventory and the customer display inventory location would simply be a web page describing such products and the point of sale would be, for example, the Internet.

In one embodiment, when a customer presents a product with an associated RFID smart tag to a checkout process (such as a cashier at a checkout counter) at a point of sale, at least one RFID Smart Tag Reader (STR) is provided in communication range of such smart tag. A first central computer is configured to use the RFID STR device to interrogate the associated smart tag and retrieve at least some of the product information stored in such smart tag thereby acquiring product-information which includes product-identification-information. The first central computer may then access either a remote or local database to retrieve at least part of the rebate-claim-information requirements for the product being purchased using the product-identification-information. Next, the first central computer acquires the rebate-claim-information, such information comprising the information needed to satisfy the rebate-claim-information requirements. The first central computer then initiates a transfer of the rebate claim information to a second central computer authorized by the manufacture to process and validate the rebate claim.

The first central computer may be further configured to receive rebate status information, ideally from the second central computer. Such rebate status information may simply indicate, for example, that the rebate claim information has been received and is complete and that the rebate claim is being processed. The first central computer then notifies the customer of the rebate claim status while the customer is at the point of sale thereby providing the customer with at least a minimum level of instant gratification.

The first central computer may be additionally configured to communicate with a customer interface. One exemplary embodiment of a customer interface is an electronic device comprising a processor, memory and a LCD screen and may be located on a shopping cart or other similar apparatus used by customers while shopping. With this configuration, the first central computer can scan the RFID tags associated with the products in a customer's cart as well as a product a customer is examining and transmit to the customer interface a real-time rebate offer for such products as well as rebate offers for possible substitute products.

In yet another embodiment of the present invention, RFID technology is used in a method for processing an electronic rebate claim. For this embodiment, at least one electronic tag device is associated with products, wherein each distinct product is associated with at least one electronic tag, and wherein said electronic tag is configured to store product-information. A first central computer, perhaps a manufacturer central computer, is configured to receive rebate-claim-information from a first remote computer located at a point of sale that generates (or causes to be generated) the rebate-claim-information. Such rebate-claim-information is generated, at least in part, using the product-information retrieved from an electronic tag associated with a product being purchased by a customer at said point of sale. The first central computer may then evaluate the validity of the rebate claim using at least part of said rebate-claim-information and initiate a transfer of rebate-claim-status-information to a computing device at the point of sale. Such rebate-claim-status-information may then be presented to said customer at said point of sale. While it is preferred that the first central computer be a manufacturer central computer, such first central computer may be a rebate processing center central computer that process rebate requests on the behalf of a manufacturer.

The first central computer may also be configured to transmit an electronic mail message to a predefined electronic mail address wherein said electronic mail message contains at least part of said rebate-claim-status-information. This electronic message may be an e-mail sent to the customer's private e-mail address.

The first central computer may be further configured to initiate an electronic fund transfer to a predefined bank account upon validating the rebate claim. The electronic fund transfer may be in the amount of the rebate and would transfer such funds from a manufacturer account into a customer account. One exemplary electronic fund transfer method is an automated clearing house (ACH) transfer.

Additional embodiments of the present subject matter, not necessarily expressed in this summarized section, may include and incorporate various combinations of aspects of features or parts referenced in the summarized objectives above, and/or features or components as otherwise discussed in this application.

Those of ordinary skill in the art will better appreciate the features and aspects of such embodiments, and others, upon review of the remainder of the specification.

### BRIEF DESCRIPTION OF THE DRAWINGS

A full and enabling description of the present subject matter, including the best mode thereof, directed to one of ordinary skill in the art, is set forth in the specification, which makes reference to the appended figures, in which:

FIG. 1 is a block diagram illustration of an exemplary supply chain incorporating a rebate redemption and processing system in accordance with one possible embodiment of the invention;

FIG. 2 is a graphic illustration of products and associated RFID smart tags in a customer inventory location;

FIG. 3 is a graphic illustration of products and associated RFID smart tags at a point of sale;

FIG. 4 is a logical flow chart of an exemplary Purchase-Routine according to the invention;

FIG. 5 is a logical flow chart of an exemplary Manufacturer-Rebate-Processing-Routine according to the invention; and

FIG. 6 is a logical flow chart of an exemplary Real-Time-Rebate-Routine according to the invention.

Repeat use of reference characters throughout the present specification and appended drawings is intended to represent same or analogous features or elements of the present technology.

### DETAILED DESCRIPTION

Reference will now be made in detail to one or more embodiments of the invention, examples of which are graphically illustrated in the drawings. Examples and embodiments are provided by way of explanation of the invention, and not meant as a limitation of the invention. For example, features illustrated or described as part of one embodiment may be utilized with another embodiment to yield still a further embodiment. It is intended that the present invention include these and other modifications and variations.

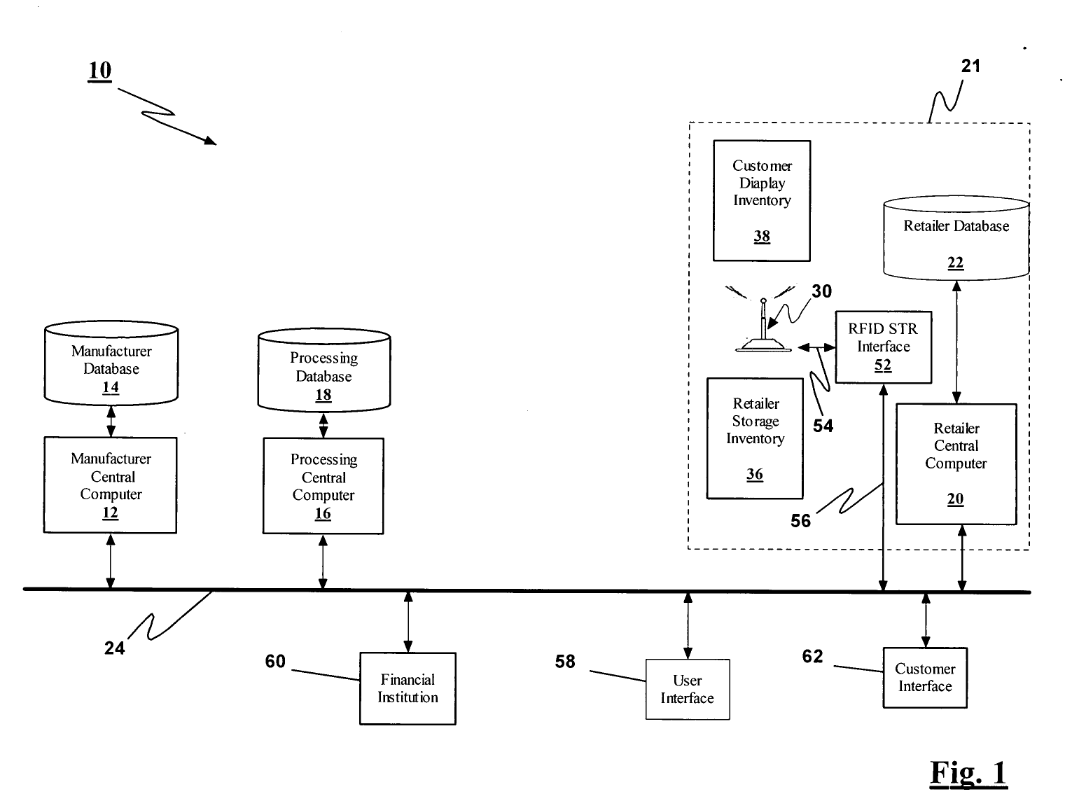

FIG. 1 is a block diagram illustration of an exemplary rebate system 10 depicting various components of a supply chain incorporating RFID technology in accordance with the present invention. Rebate system 10 represents a retail supply chain for any type of product and includes a manufacturer central computer 12 associated with a manufacturer database 14, a processing central computer 16 associated with a processing database 18 and a retailer central computer 20 associated with a retailer database 22, all interconnected via a standard wired and/or wireless communication link 24. It should be appreciated that any one of the manufacturer central computer 12, processing central computer 16 and retailer central computer 20 may be connected to a common database without departing from the scope of the invention and methodology. For example, manufacturer database 14 and processing database 18 may be incorporated into a single database.

RFID Smart Tag Reader (STR) 30 represents at least one smart tag reader (sometimes referred to as RFID scanners) of conventional design and is used to retrieve the information contained in RFID smart tags. RFID STR device 30 is an electronic device that may, for example, comprise an RF transmitter and receiver and an antenna to communicate with RFID transponders, such as RFID smart tags. Such an RFID STR device may include a microprocessor and software programs for this purpose. Exemplary readers include Martics® Advanced Readers manufactured by Matrics, Inc. (Columbia, Md.), Alien Technology (Morgan Hill, Calif.), or Philips Semiconductor (Eindhoven, The Netherlands). Another example of an RFID STR device is an RFID reader manufactured by Antenova Ltd. (Cambridge, England) or Bancolini B30 handheld RFID Scanner manufactured by Bancolini (Bologna, Itally).

RFID STR 30 may be accessed through RFID STR interface 52. Such RFID STR interface may be, for example, a standard PC or PDA device incorporating a digital interface designed to facilitate communication between RFID STR devices and a computing device connected to wired or wireless communication link 24. RFID STR interface 52 may comprise a gateway for connecting two otherwise incompatible systems. Interface 52 may also be incorporated into retailer central computer 20.

RFID Smart Tag Reader 30 represents one or more RFID STR devices disposed at various locations at retailer store 21. To facilitate remote access to such RFID STR devices, a networking system, such as a local area network (LAN) may be utilized. In one embodiment, such RFID STR devices incorporate a TCP/IP protocol suite and an HTTP (HyperText Transfer Protocol) server to provide two-way access to the RFID STR data. Such TCP/IP protocols and HTTP server technology are well known in the art. For such an embodiment, the RFID STR devices include an HTTP server and a TCP/IP protocol stack. The RFID STR interface 52 may provide a gateway which enables continuous remote access to the RFID STR devices. Generally speaking, a gateway may simply be a means for connecting two compatible systems. Alternatively, a gateway may be a means for connecting two otherwise incompatible computer systems.

For such an alternative configuration, the TCP/IP protocol suite may be incorporated into a gateway serving multiple RFID STR devices via a wired or wireless two-way network using, for example, Wireless Fidelity (Wi-Fi) technology or Bluetooth. The gateway may incorporate an HTTP server for accessing data from multiple RFID STR devices and for transmission of data to individual RFID STR devices.

In the above described TCP/IP enabled RFID STR systems, communications link 24 provides access to a first network operating in accordance with a predetermined protocol (TCP/IP is one example). A plurality of RFID STR devices may comprise a second network, such as a LAN. A gateway operatively couples the first network to the second network. Finally, an HTTP server is embedded in either the gateway or the plurality of RFID STR devices facilitating the transfer of data between the two networks. With such a configuration, one of ordinary skill in the art will appreciate that individual RFID STR devices or groups of RFID STR devices may be accessed as if the STR devices were a web site and their information could be displayed on a web browser.

Such technology is fully disclosed by Ardalan et al. in U.S. Pat. No. 6,363,057 for use in a system for communicating with electricity meters, which is hereby incorporated by reference for all purposes.

RFID STR 30 represents one or more RFID STR devices located at retailer storage inventory 36 and customer display inventory 38. RFID STR 30 is connected to RFID STR interface 52 via a wired or wireless communications link 54. With such a configuration, either of manufacturer central computer 12, processing central computer 16, retailer central computer 20, user interface 58 and any properly configured computing device connected to communications link 24 may transmit and receive data to and from RFID STR 30.

User interface 58 represents one or more devices designed for providing access to electronic data systems. Such devices include a computer, a terminal, PDA or any digital device configured for accessing data systems. One or more user interface 58 devices may be located wherever access is required to RFID system 10.

Ideally, communications link 24 provides a standard two way communication link between rebate system 10 and networks external to the retailer network, although Intranet computers may also be accessed through such a link. An Internet link is one example of such a link. For example, retailer central computer 20, processing central computer 16 and manufacturer central computer 12 may utilize communications link 24 to initiate an electronic fund transfer, which will be described in more detail below. In addition, potential customers may use communications link 24 to shop for products sold by a retailer while obtaining real-time product inventory data (or near real-time data) as well as other information related to such desired products.

Near real-time data is generally defined as “old” real-time data that has been stored in a memory but not so old that such near real-time data would likely be significantly different, if different at all, from real time data. For example, suppose that inventory data for product X is requested at 10:00 a.m. and a computer already has inventory data for product X stored in a memory that was generated at 9:59 a.m. The 9:59 a.m. inventory data may be near real-time data. Such near real-time data would likely be quicker and cheaper to access than real-time although such data may not represent with 100% accuracy the current inventory status. In contrast, real-time inventory data represents the current inventory status of the product at the inventory location of interest (such as customer display inventory 38) at the moment of scanning the relevant smart tags in response to an inventory data information request.

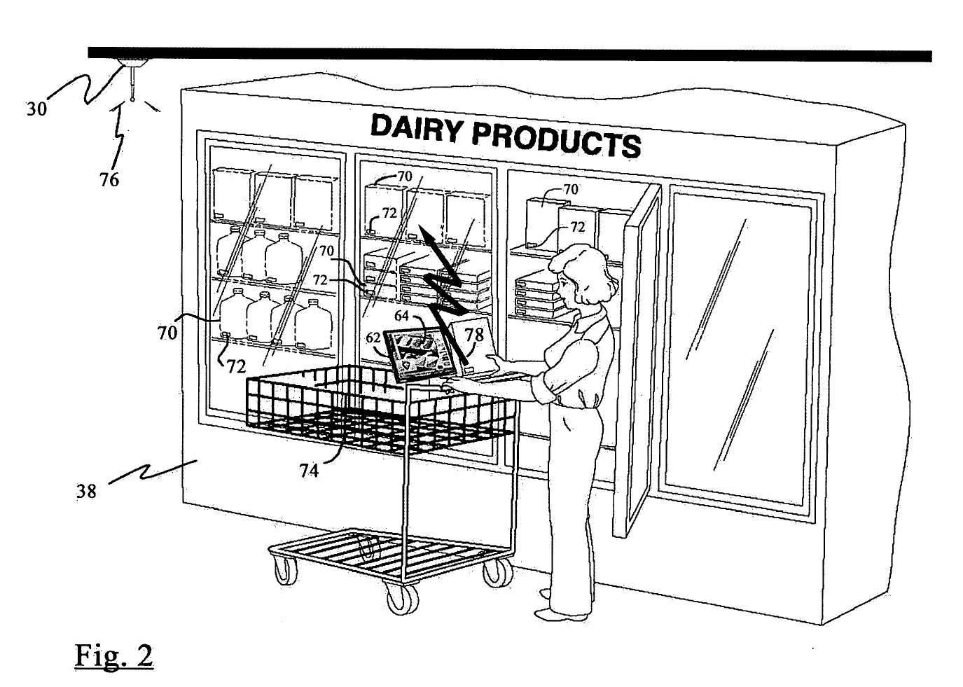

Customer interface 62 is shown in both FIG. 1 and FIG. 2. Customer interface 62 may be an electronic device supplied by the retailer and used by a customer while shopping for products. Customer interface 62 may have a conventional hardware and software architectural design suitably adapted for sending message to, and receiving messages from, a central computer (such as retailer central computer 20) and/or RFID STR devices (such as RFID STR 30). While customer interface 62 is portrayed as having a built-in visual display screen 64, it should be recognized that customer interface 62 may comprise a plurality of physically separated but cooperatively associated electronic devices that are not shown independently such as a radiofrequency transmitter and receiver, a processor, one or more display means such as a visual display screen 64, a magnetic card reader, an audio speaker, and the like, each communicating with or under control of the a central computer, such as central computer 20. The customer interface 62 may incorporate an alarm or alert feature wherein the consumer is notified of special product offerings such as rebate offerings. Customer interface 62 may also comprise an RFID STR device.

Again referring to FIG. 2, exemplary retailer products 70 stored in customer display inventory 38 are shown. In the FIG. 2 illustrated embodiment, the products 70 are food products. It should be appreciated that this is for purposes of illustration only. The products may just as well be clothing items, hardware items, and other staple items of commerce. Such exemplary retailer products 70 are provided or associated with respective RFID smart tags 72. RFID smart tags 72 are electronic tags for storing and conveying information. As discussed in greater detail below, the smart tags 72 transmit a coded pulsed signal 78 containing product information in response to an electronic “trigger” 76 from RFID STR 30.

The smart tags 72 may be attached directly to the products 70, as illustrated in FIG. 2. In this embodiment, the smart tags 72 may be, for example, adhesive backed labels or tags that are attached directly to the packaging of the products 70. Alternatively, such smart tags 72 may be attached to containers that are specially designed to hold such products. For example, a toothbrush and its associated factory packaging could be placed in a tubular container where a smart tag 72 is attached to said tubular container. Such container may be reusable.

In general, as shown in FIG. 2, a different smart tag 72 is associated with each distinct product. For example, if the retailer carries three different brands of milk, then a different smart tag may be associated with each brand. Similarly, if three different size containers of the same brand of milk are carried by the store, then a different smart tag 72 may be associated with each different sized container. Smart tags may be made “different” by their hardware design or simply by the information stored in such smart tags.

The product information stored in the smart tags 72 is not limited in scope, and may include, for example, information identifying the type of product, brand name of product, manufacturer of the product, product model number, product serial number, rebate promotion code, proof-of-purchase code, an electronic mail address, etc. In addition, such smart tags may include a rebate information list describing the rebate information requirements for a particular product. In the alternative, a product identifier (such as product serial number, rebate promotion code, etc.) may be used to look up a rebate information list stored in a database.

The type of product information stored in smart tags 72 is ideally adequate to correlate with various manners of listing and identifying a product and to facilitate locating promotional documentation and implementation of anti-fraud protection. For example, a proof-of-purchase code may be an encrypted code stored in an RFID tag wherein such code must be supplied with a rebate request in its unencrypted form. Preferably, only the manufacturer or retailer would be able to generate the unencrypted form of the proof-of-purchase code. The stored product information should also be adequate to assimilate all reasonable conceivable methods of listing desired products and locating product information in a database such as retailer database 22.

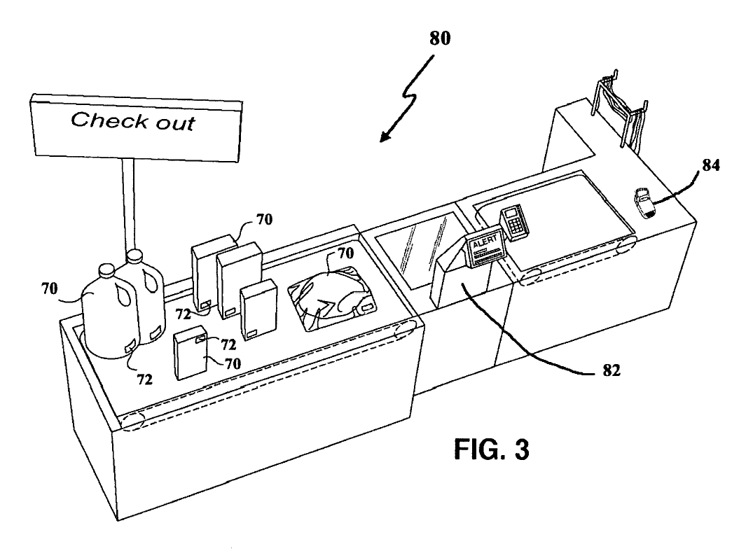

Referring now to FIG. 3, RFID products at an exemplary point-of-sale are shown. In FIG. 3, exemplary retailer products 70 associated with respective RFID smart tags 72 and a point-of-sale computer 82 (perhaps incorporating an RFID STR 30 device) are shown. Such point-of-sale computer 82 may be in communication with, and under the control of, retailer central computer 20. With this configuration, retailer central computer 20 can scan the RFID tags 72 and retrieve product-information wherein such product-information includes rebate-identification-information. Exemplary rebate-identification-information includes (a) a product model number; (b) product serial number; (c) rebate promotion code; (d) product name; (e) identification code; (f) proof-of-purchase code and (g) an electronic address.

FIG. 3 also depicts a hand held computer 84, such as a PDA. Such a hand held computer may be owned by the customer and is configured to communicate with at least one of retailer computer 20, manufacturer computer 12 and processing computer 16. Hand held computer 84 communicates with the retailer computer 20, for example, using wireless technology such as Wi-Fi, infra-red, integrated cell phone or other wireless communication techniques. Hand held computer 84 may be capable of receiving e-mail, text messages, instant messages or other forms of communication initiated by other computing devices such as retailer computer 20. With such a system, a paperless transaction can be achieved as a sales receipt and all other purchase related documentation, including rebate related documentation, could be transmitted from retailer computer 20 to hand held computer 84. Such functionality provides a customer with an efficient electronic, possibly automatic, means for tracking purchasing data over time. More particularly, such functionality provides one method of transferring rebate claim status information to customers while such customers are at the point of sale as well as after leaving the point of sale.

As noted above, all rebate-information-requirements may be stored in RFID tags 72. Alternatively, rebate-information-requirements may be stored in a database indexed by some form of product identification information, such as a product identification code. The retailer central computer 20 may be further configured to use such production-identification-information to access retailer database 22, for example, to retrieve rebate-claim-information requirements. Alternatively, retailer central computer could be configured to use an electronic address, such as an URL, to link to a web site containing the rebate-claim-information requirements. Such rebate-claim-information requirements would ideally be automatically downloaded to retailer central computer 20. Alternatively, such rebate-claim-information requirements may be stored in retailer database 22.

It should be noted that such rebate-claim-information requirements represent the information a manufacturer needs to process a rebate claim. Exemplary rebate-claim-information requirements may include any combination of: (a) customer name; (b) a financial institution tracking number; (c) an account number at a financial institution; (d) customer's mailing address; (e) customer's e-mail address; (f) customer's phone number; (g) customer's credit card number; (h) customer's debit card number; (i) a pin code; ( ) an authorization code; (k) customer's electronic signature; (I) product model number; (m) product serial number; (n) rebate promotion code; (O) product name; (p) an electronic address; (q) proof-of-purchase code; (r) date of purchase; (s) time of purchase; (t) product identification code; (u) product information; (v) retailer name; (w) retailer location; (x) retailer identification code; and (y) a transaction code.

The retailer central computer 20 may be further configured to accumulate or generate the rebate-claim-information needed by a manufacturer to process a rebate claim and to initiate a transfer of such information to manufacturer central computer 12 or processing central computer 16.

Referring now to conventional RFID “smart” systems, the smart tags 72 are passive devices. As shown in FIG. 2, RFID STR 30 emits a trigger excitation signal 76 received by an internal antenna in the smart tag 72. This signal 76 causes the smart tag 72 to generate and transmit signal 78, an electromagnetic pulse of coded digital data containing the product identification information. The coded signal 78 is received by the RFID STR 30 or customer interface 62, decoded, and the product identification information is presented to retailer central computer 20, in any number of ways. Retailer central computer 20 may then transfer any relevant product information to customer interface 62. In the alternative, coded signal 78 may be received directly by customer interface 62 and decoded or the coded signal 78 data may be sent to retailer central computer 20 for decoding.

RFID smart tag technology is known and understood by those skilled in the art, and a detailed explanation thereof is not necessary for purposes of describing the method and system according to the present invention. Generally, conductive or passive smart tags 72 consist of silicon or other semiconductors, a coiled, etched, or stamped antenna, a capacitor, and a substrate on which the components are mounted or embedded. A protective covering is typically used to encapsulate and seal the substrate. Inductive or passive smart tags have been introduced by Motorola under the name “BiStatix”. A detailed description of the BiStatix device may be found in U.S. Pat. No. 6,259,367 B1, incorporated herein by reference in its entirety for all purposes. Another commercial source of suitable smart tags is Alien Technology Corporation of Morgan Hill, Calif., under the technology name FSA (Fluidic Self-Assembly). With the FSA process, tiny semi-conductor devices are assembled into rolls of flexible plastic. The resulting “smart” substrate can be attached or embedded in a variety of surfaces. The smart tag technology under development at the Auto-ID Center at Massachusetts Institute of Technology (Cambridge, Mass.) can also be used within the scope of the present invention. Further information on smart tags and related technology is disclosed in U.S. Pat. No. 6,451,154, “RFID Manufacturing Concepts,” issued Sep. 17, 2002 to Grabau et al.; U.S. Pat. No. 6,354,493, “System and Method for Finding a Specific RFID Tagged Article Located in a Plurality of RFID Tagged Articles,” issued Mar. 12, 2002 to Mon; PCT publication WO 02/48955, published Jun. 20, 2002; U.S. Pat. No. 6,362,738, “Reader for Use in a Radio Frequency Identification System and Method,” issued Mar. 26, 2002 to Vega; D. McFarlane, “Auto-ID Based Control,” White Paper for the Auto-ID Centre Institute for Manufacturing, University of Cambridge, Cambridge, United Kingdom, Feb. 1, 2002, available at www.autoidcenter.org/research/CAM-AUTOID-WH-004.pdf; and Chien Yaw Wong, “Integration of Auto-ID Tagging System with Holonic Manufacturing Systems,” White Paper for the Auto-ID Centre Institute for Manufacturing, University of Cambridge, Cambridge, United Kingdom, September 2001, available at www.autoidcenter.org/research/CAM-WH-001.pdf. Such references are hereby incorporated herein by reference in their entirety for all allowed purposes.

Other RFID technologies believed to be of value for the present invention includes those produced by Microchip Technologies (Chandler, Ariz.), which provides remote read-write chips at several frequencies. Also of potential value are the I*CODE chips and readers of Philips Semiconductor (Eindhoven, The Netherlands), which, in one embodiment, are said to include 384 bit configurable read/write memory with 64 bits for a unique serial number (e.g., an electronic product code). Sokymat (Lausanne, Switzerland) markets the PICCOLO read-only RFID disc tag which transmits data to a reader station by an AM radio signal. The tag is said to have 64 bits of data that can be programmed during manufacturer by laser fusing of polysilicon links in order to store a unique code on each tag.

Texas Instruments (Dallas, Tex.) offers RFID technology as part of Texas Instruments RFID (TI*RFID™) Systems, formerly known as the TIRIS™ system (Texas Instruments Registration and Identification System), which is used to track and identify various assets using devices such as the TI Tag It™ chip.

Gemplus (Gemenos, France) provides smart tags (sometimes called “smart labels”) and smart cards employing RFID technology, which may be used as smart tags. They also market interfaces, antennas, scanners and software that can be adapted for use with smart tags.

Nedap (Groenlo, The Netherlands) provides smart cards and a13.56 MHz smart tag using RFID technology with 512 bits of read-write memory with a range of about 120 cm. It is claimed that about 20 such tags per second can be read successfully by a scanner.

Checkpoint Systems Inc. (Miami, Fla.) offers a smart tag with WORM technology (write once, read many). One example is the MCRF355 chip, described more fully at www.idsystems.com/reader/1999_{—}05/join0599.htm.

PDA-like reader systems and other portable readers for RFID technology are marketed by Omron Company (Tokyo, Japan), such as the Model V700 or V720 series.

High frequency bands can be used in RFID technology, such as bands between 300 MHz and 10 GHz. SCS Corporation (Rancho Bernardo, Calif.), for example, markets smart tag technology at 2.45 GHz. Ultra-wide band technology can also be adapted for RFID systems.

A related technology within the scope of the present invention is Surface Acoustic Wave (SAW) technology. For example, InfoRay (Cambridge, Mass.) markets a passive smart tag that is said to achieve long ranges (up to 30 meters) using a Surface Acoustic Wave (SAW) device on a chip coupled with an antenna. The SAW device converts a radio signal to an acoustic wave, modulates it with an ID code, then transforms it to another radio signal that is emitted by the smart tag and read by a scanner. The ID code of the smart tag is extracted from the radio signal. The scanner is said to compare the spectral content of the signal with a database of signatures and to derive the ID code. This method enables a read range of up to 30 m (typical 10-20 m). The system can operate in the 915 MHz band and 2.45 GHz band. RFSAW, Inc. (Dallas, Tex.) also provides minute Surface Acoustic Wave (SAW) RFID devices that can be used within the scope of the present invention.

The antenna embedded within the smart tags 72 is generally one component of the device, though it is recognized that alternatives to antennas may exist in some applications. For example, for some metallic objects, the smart tag need not comprise an antenna but the metallic object itself can serve as the antenna. The excitation signal 76 from the RFID STR 30 can be received by the antenna to “activate” the smart tag. The received excitation signal 76 is the power source for the smart tag 72 and results in the generation of the electromagnetic pulse containing the coded product identification information signal 78. A detailed description of RFID smart tag antennas may be found in U.S. Pat. No. 6,320,556 B1, incorporated herein by reference for all purposes.

In an alternate embodiment, the smart tags 72 may be active devices. In this configuration, the smart tag 72 includes active transceiving circuitry that has the capability to selectively respond to coded request signals transmitted by an RFID STR 30. The active smart tag 72 may include the capability to delete their fixed code and receive new or additional information beyond the information contained in its fixed code. An active smart tag 72 requires an internal power supply, such as a micro-battery, thin film battery, or the like. Active tags 72 may be desired in the scenarios wherein the tags 72 are mounted at storage locations of particular products. In this way, as different products are stored at the respective locations, the smart tags 72 can be programmed accordingly.

Manufacturer central computer 12, processing central computer 16 and retailer central computer 20 may also be configured to communicate with financial institution computers via communications link 24. Through such functionality, electronic fund transfers are made from a manufacturer's account into a customer's account in the amount of the rebate to be refunded to a customer. The preferred electronic fund transfer method is an Automated Clearing House (ACH) transfer. Such electronic payments are typically transactions within the ACH Network, an electronic payment system linking more than 12,000 financial institutions and 2.5 million business organizations across the United States. The ACH Network is commonly used for direct deposit of payroll and Social Security payments, direct payments of consumer bills and corporate payments and such ACH transfers are well known in the art. The Operating Rules of the National Automated Clearing House Association specify the formats for ACH transactions and define the rights, obligations and warranties of parties involved in ACH transactions. Such ACH transfers typically cost less than a penny (as of the year 2003) which offers a much less expensive method of issuing a rebate payment to a customer compared to printing a check, enclosing such check in an envelope and mailing the check to the customer.

Manufacturer central computer 12 may also be configured to receive rebate claim information from a computing device located at a point of sale. Alternatively, processing central computer 16 may be configured to perform such task for a manufacturer. Such rebate claim information represents the information that a manufacturer has defined as being required to process a rebate request for a particular product. As previously noted, the manufacturer may program a smart tag with product identification information which can be used to locate a description (such as a list) of the rebate claim information requirements. Such rebate claim requirements may be stored, for example, in manufacturer database 14, processing center database 18 and retailer database 22 or totally within an RFID tag.

The manufacturer central computer 16 is configured to process the received rebated claim information and to validate such information. If a valid claim has been presented, manufacturer central computer 16 is configured to initiate a rebate payment, ideally via an electronic fund transfer. If an invalid rebated claim is detected, manufacturer central computer 16 is configured to deny the rebate request. Manufacturer central computer may be further configured to generate rebate status information and transmit such information back to the point of sale.

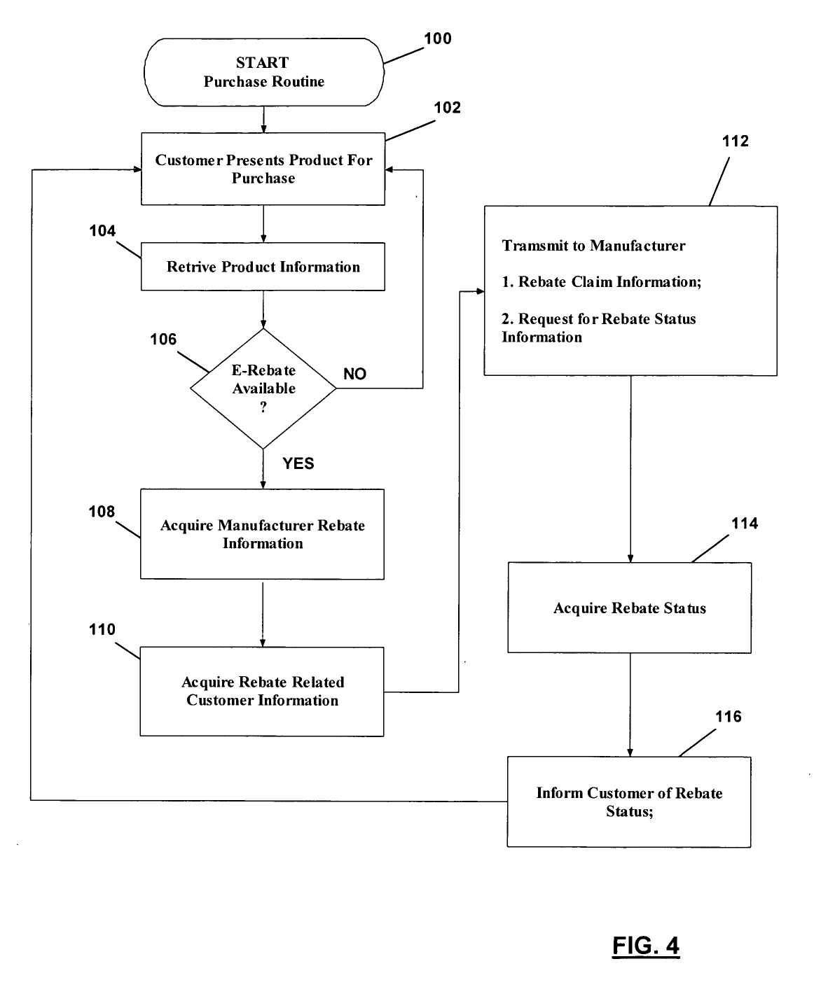

Examples of methodologies for using rebate system 10 are now discussed. FIG. 4 is a high level block diagram depicting exemplary logic for a Purchase-Routine using rebate system 10. Such a Purchase-Routine is preferably implemented in software executed at least in part by retailer central computer 20 or point-of-sale computer 82. It should be appreciated, however, that any computer with access to communications link 24 may be the computer executing the Purchase-Routine and hereafter such computer will simply be referred to as the “central computer”. Step 100 marks the entry point into the exemplary Purchase-Routine shown in FIG. 4. At step 102, the central computer scans an RFID tag 72 associated with a product 70 to retrieve at least part of the product-information stored in such RFID tag. It should be appreciated that such product 70 would typically be presented by a customer for purchase at a point-of-sale 80.

Exemplary product-information preferably includes rebate-identification-information such as: (a) product model number; (b) product serial number; (c) rebate promotion code; (d) product name; (e) identification code; (f) proof-of-purchase code; or (g) an electronic address. One of ordinary skill in the art will understand that such product-information or rebate-identification-information should be suitable for use by the central computer for accessing product related information for the product associated with the RFID tag being scanned. For example, assume an RFID tag is scanned by the central computer whereby production-information is retrieved containing the identification code “123456”. The central computer may then access file 123456 in retailer database 22 (which preferably contains a wide variety of product information) and retrieve the rebate-claim-information requirements for the product being purchased. Such rebate-claim-information requirements may be in the form of an electronic list, such list consisting of descriptions of the information required from a customer to process a rebate claim. For example, customer name, customer address, product serial number and so forth are examples of such descriptions.

At step 104, the central computer accumulates the rebate-claim-information requirements for the product being purchased. The step of accumulating the rebate-claim-information may involve accessing the necessary data source(s) to retrieve a description (such as a list) of the information a manufacturer requires to process a rebated claim. Preferably, only one data source (such as the retailer database 22 or manufacturer database 18) would need to be accessed to retrieve such information; however a plurality of data sources may be accessed to retrieve such information. Exemplary rebate-claim-information requirements may include any combination of: (a) customer name; (b) a financial institution tracking number; (c) a account number at a financial institution; (d) customer's mailing address; (e) customer's e-mail address; (f) customer's phone number; (g) customer's credit card number; (h) customer's debit card number; (i) a pin code; (j) an authorization code; (k) customer's electronic signature; (I) product model number; (m) product serial number; (n) rebate promotion code; (o) product name; (p) an electronic address; (q) proof-of-purchase code; (r) date of purchase; (s) time of purchase; (t) product identification code; (u) product information; (v) retailer name; (w) retailer location; (x) retailer identification code; and (y) transaction code.

Most of the above presented rebate-claim-information requirement terms are self-explanatory and will not be discussed, however, some of the less obvious terms will now be described. The financial institution tracking number and account number may be used, for example, in electronic fund transfer (EFT) transactions. An authorization code and/or customer's electronic signature may be used to authorize transactions such as EFTs. A proof-of-purchase code may be the encrypted or unencrypted form of an encrypted code stored in an electronic tag associated with a product. Preferably, only the manufacturer or retailer can generate the unencrypted form (useful in an anti-fraud protection system). A rebate promotion code may contain a code signifying whether a rebate is available for a particular product. Such code may simply be the value “0” (zero), for no rebate offered, or 1, for rebated offered.

At step 106 the central computer determines if a rebate offer is available for the product being purchased. Such may be accomplished, for example, by examining a rebate promotion code. If no rebated is offered, program control is returned step 102 where the central computer waits for a customer to present the next product to be purchased or the central computer automatically scans the next product in a shopping cart. If, however, a rebate is offered for the product being purchased, at step 108 the central computer acquires the rebated-claim-information. In an alternative embodiment, step 106 is simply eliminated and program execution would proceed directly to step 108 from step 104.

At step 108, the central computer generates and/or acquires the necessary rebate-claim-information a manufacturer requires to process a rebate claim. To acquire the rebate-claim-information, the central computer may be required to access several data sources. For example, the central computer may access its own system components to acquire the date of purchase, time of purchase, transaction code, and retailer identification. Some of the rebated-claim-information may be acquired from the customer, such as the customer name, where such information may be obtained automatically via communications between the central computer, for example, and hand held computer 84. Alternatively, a customer may have an RFID smart tag or an ID card programmed with the information commonly requested from customers where such tags or cards are scanned or read by the central computer. Other rebated related information may be acquired by connecting to an external database.

After acquiring the rebate-claim-information, at step 112 the central computer preferably initiates a transfer of such information to a rebate processing computer. Exemplary processing computers include manufacturer central computer 12 and processing central computer 16. At step 114, the central computer may also request rebated claim status information from the rebate processing computer. Exemplary rebate status information may include: rebate approved message, rebate denial message, rebate denial code, rebate reference code, EFT transaction code, e-mail notification notice, and a rebate check number.

At step 116, the central computer presents at least part of the rebate-status-information to a customer at the point of sale. For example, if a valid rebate claim is received by the rebate processing computer, the rebate processing computer may send rebate status information back to the central computer stating that the rebate was approved, specifying a rebate reference number and indicating that an EFT has been initiated. The central computer preferably presents at least part of such rebate-status-information to the customer at the point sale. Such functionality provides at least a minimal level of instant gratification to the customer.

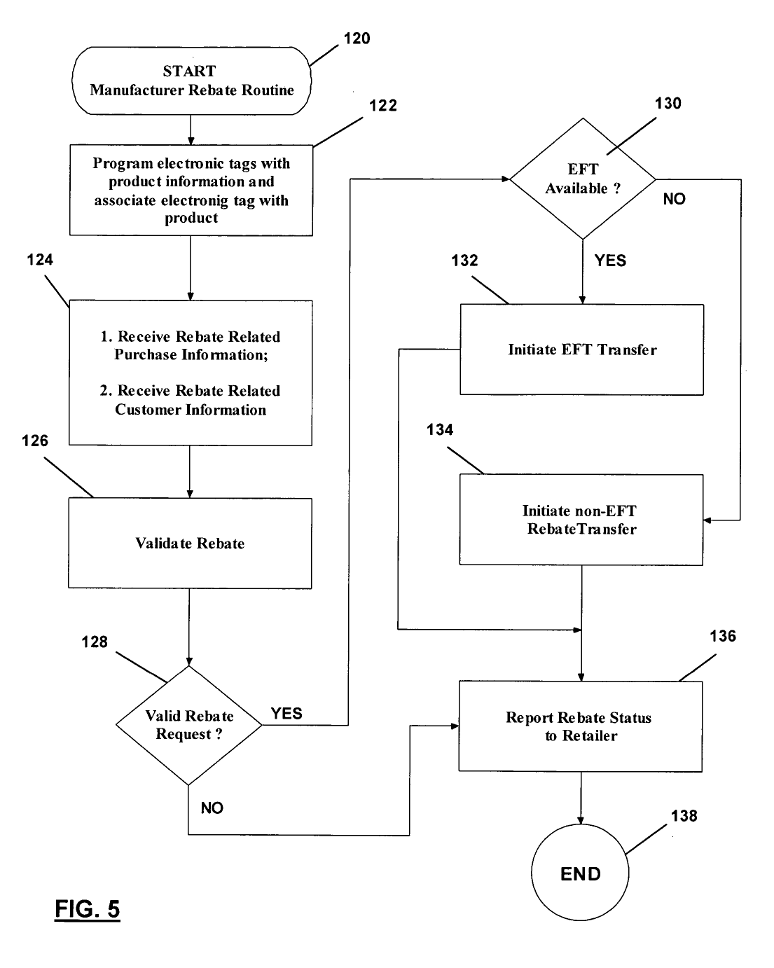

Attention now is directed to FIG. 5 which depicts an exemplary Manufacturer-Rebate-Routine. Step 120 marks entry into the routine. At step 122, a manufacturer programs product information into an electronic tag (such as an RFID smart tag) and associates such electronic tag with products. While such programming and associating of electronic tags is preferably performed at the manufacturer's facility where a product is manufactured, such steps may be performed at any point between the manufacturer's facility and the point of sale. At step 124, a first central computer is configured to receive rebate-claim-information for a product being purchased at a point of sale. Such rebated-claim information was preferably assembled by a second central computer (such as retailer central computer 20) preferably located at said point of sale. At step 126, the first central computer evaluates the received rebate-claim-information to determine if such information represents a valid rebated request. If the first central computer determines that an invalid rebated request has been received, at step 136 the appropriated rebate-status-information may be transmitted back to the second central computer, for example, indicating that an invalid rebate request has been received. If however, at step 126, the first central computer determines that a valid rebated request has been received, at step 130 the first central computer determines if an electronic fund transfer is authorized. If the first central computer determines that an EFT is authorized, an EFT transaction is initiated where funds are transferred (or scheduled for transfer) from a manufacturer's financial account to a designated customer account (step 132). The transfer amount is preferably equal to the amount of the rebate. Program control then jumps to step 136 where rebate-status-information is transferred to the second central computer as previously described. The status of the EFT transaction is preferably included in such rebate-status-information.

If however, at step 130 the first central computer determines that an electronic fund transfer is not authorized, program control jumps to step 134. At step 134 the first central computer initiates a non-EFT rebate payment process, such as printing a check and mailing such check to a customer's mailing address. Program control then continues to step 136 where rebate-status-information may be transferred to the second central computer as previously described. The status of the non-EFT transaction is preferably included in such rebate-status-information.

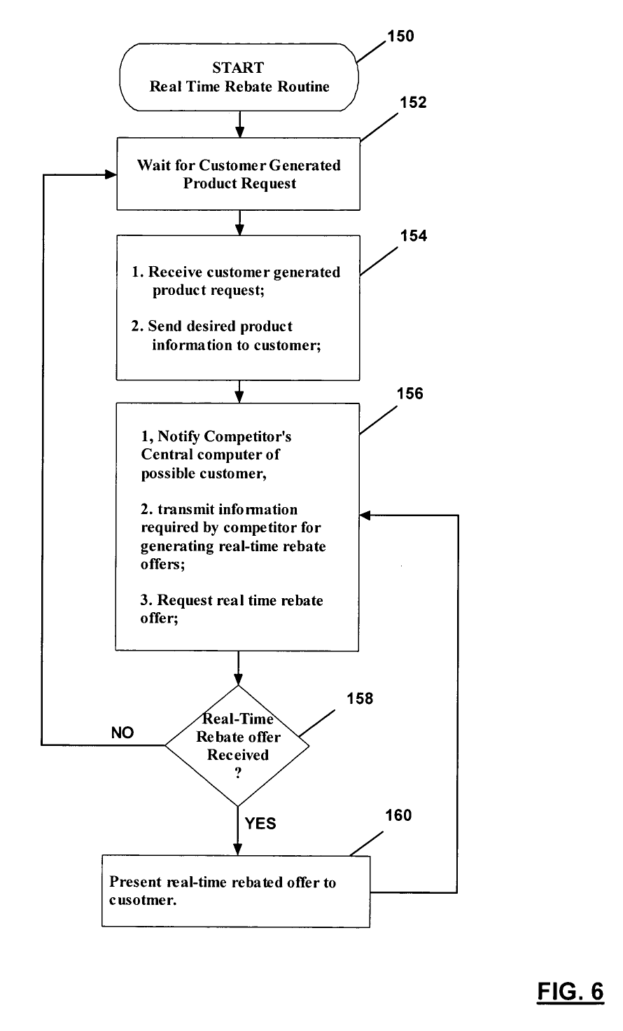

Referring now to FIG. 6, a method for issuing real-time or near real-time rebate offers is now considered. In regards to rebate offers, a “near real-time” rebate offer is a rebate offer that has been recently generated but technically is not a real-time rebate offer. For example, suppose a manufacturer decides at 10:00 am on day X to initiate a rebated offer for a particular product. The manufacturer transmits to retailers such a rebate offer at 10:00 am that same day. While such a rebated offer could be presented to customers almost immediately, a customer may receive such a rebated offer at 2:00 pm on day X. Such a rebated offer would technically not be a “real-time” rebate offer, however, such offer is considered to be a near real-time offer (for the purposes of the invention).

Step 150 marks the entry point into a real-time rebated routine according to an embodiment of the invention. At step 152, retailer central computer 20 is waiting for a customer generated product request. Customer generated product requests may be generated, for example, by a customer using customer interface 62 or hand held computer 84. At step 154, retailer central computer 20 has received a customer generated product request and has sent the relevant product information to the customer. For example, assume for a moment that such a customer product request is for MFG. A's 36″ plasma television set. For such example, central computer 20 may transmit to customer interface 62 (or hand held computer 84) product information for the requested product. Such information may include, for example, the location of such product within the retailer store, the product price and any purchasing incentives (such as rebates). At step 156, central computer 20 then notifies a competitor's central computer of a possible customer and inquires about possible real-time rebate offers. For example, retailer central computer 20 may notify MFG. B's central computer that a customer is considering purchasing MFG. A's 36″ plasma television for X dollars and that MFG. B's 36″ plasma televisions are being sold for X+50 dollars. It should be noted that MFG. B may require retailer central computer 20 to provide additional information before making such a real-time rebate offer, such as retailer markup, inventory levels, technical specifications on MFG. A's television, and other such information. MFG. B may then issue a real-time rebate offer of $75, for example, to the customer. At step 158, retailer central computer 20 checks for such a real-time rebate offer. If no rebate offer is received, program control returns back to step 152. If, however, a real-time rebate offer is received, such a rebated offer is presented to the customer and program control jumps back to step 156. At step 156, using the above example, MFG. A is now the “competitor” and MFG. A will be notified of a potential customer and that MFG. B is selling its 36″ plasma television for X-25 dollars. Retailer central computer 20 may then request a real-time rebated offer from MFG. A. The above described process preferably repeats until no new rebate offer is received, a purchase is made or the customer terminates the process.

While the present subject matter has been described in detail with respect to specific embodiments thereof, it will be appreciated that those skilled in the art, upon attaining an understanding of the foregoing may readily adapt the present technology for alterations to, variations of, and equivalents to such embodiments. Accordingly, the scope of the present disclosure is by way of example rather than by way of limitation, and the subject disclosure does not preclude inclusion of such modifications, variations, and/or additions to the present subject matter as would be readily apparent to one of ordinary skill in the art.

It should also be appreciated that the system and method according to the invention are not limited to any particular type of commercial or market scenario, but have application wherever consumer goods or products are typically purchased.

1. An electronic rebate system comprising:
at least one electronic tag device associated with products, wherein each distinct product is associated with at least one electronic tag, and wherein said electronic tag stores product-identification-information;
at least one electronic reading device configured to retrieve information from said electronic tag;
a first computer in communication with said electronic reading device to retrieve said product-identification-information stored in an electronic tag associated with a product being purchased by a customer at a point of sale;
said first computer further configured to use said product-identification-information to acquire rebate-claim-information; and
said first computer further configured to communicate with a second computer and to transfer to said second computer said rebate-claim-information and wherein said transfer occurs substantially contemporaneous with the purchase.

2. An electronic rebate system as in claim 1, wherein said electronic tag device is an RFID smart tag.

3. An electronic rebate system as in claim 1, wherein said electronic reading device is an RFID STR device.

4. An electronic rebate system as in claim 1, further comprising a customer interface configured to receive product-rebate-information from at least one of said first computer and said second computer.

5. An electronic rebate system as in claim 4, wherein said product-rebate-information is one of real-time information and near real-time information.

6. An electronic rebate system as in claim 1, wherein said product-identification-information comprises at least one member from the group consisting of: (a) product model number; (b) product serial number; (c) rebate promotion code; (d) product name; (e) identification code; (f) proof-of-purchase code; and (g) an electronic address.

7. An electronic rebate system as in claim 1, wherein said rebate-claim-information comprises at least one member from the group consisting of: (a) customer name; (b) customer's financial institution tracking number; (c) customer's account number at customer's financial institution; (d) customer's mailing address; (e) customer's e-mail address; (f) customer's phone number; (g) customer's credit card number; (h) customer's debit card number; (i) a pin code; (j) an authorization code; (k) customer's electronic signature; (l) product model number; (m) product serial number; (n) rebate promotion code; (o) product name; (p) an electronic address; (q) proof-of-purchase code; (r) date of purchase; (s) time of purchase; (t) product identification code; (u) product information; (v) retailer name; (w) retailer location; (x) retailer identification code; and (y) transaction code.

8. An electronic rebate system as in claim 1, wherein said first computer is further configured to receive rebate status information.

9. An electronic rebate system as in claim 8, wherein said first computer is further configured to generate at least one of (a) rebate status documentation comprising at least part of said rebate status information wherein said rebate status documentation is given to the customer at the point of sale and (b) a receipt comprising at least part of said rebate status information wherein said receipt is given to the customer at the point of sale.

10. An electronic rebate system as in claim 8, wherein said rebate status information comprises at least one member from the group consisting of: (a) rebate claim accepted notice; (b) rebate claim denied notice; (c) rebate claim denied code; (d) rebate claim reference code; (e) EFT transaction code; (g) e-mail notice; and (h) rebate check number.

11. An electronic rebate system as in claim 1, wherein said first computer is a retailer central computer.

12. An electronic rebate system as in claim 11, wherein said second computer is one of (a) a manufacturer central computer and (b) a rebate processing center central computer.

13. An electronic rebate system comprising:
at least one electronic reading device configured to retrieve information stored in an electronic tag associated with a product being purchased by a customer at a point of sale;
a first computer in communication with said electronic reading device to retrieve product identification information from said electronic tag;
said first computer further configured to use said product-identification-information to determine rebate-claim-information requirements and to acquire rebate-claim-information;
said first computer further configured to communicate with a second computer and to transfer to said second computer said rebate-claim-information; and
said first computer further configured to receive rebate-claim status information from a remote computer and to present at least part of said rebate-claim-status information to said customer at a point of sale.

14. An electronic rebate system as in claim 13, wherein said electronic tag is an RFID smart tag and said electronic reading device is an RFID STR device.

15. An electronic rebate system as in claim 13, wherein said second computer is one of a manufacturer central computer and a third party computer.

16. An electronic rebate system as in claim 13, wherein said second computer is the remote computer.

17. An electronic rebate system as in claim 13, wherein said rebate status information comprises at least one member from the group consisting of: (a) rebate accepted notice; (b) rebate denied notice; (c) rebate denied code; (d) rebate reference code; (e) EFT transaction code; (f) e-mail notification notice; and (h) rebate check number.

18. An electronic rebate processing system comprising:
a first computer configured to receive rebate-claim-information from a first remote computer;
wherein said rebate-claim-information relates to a product being purchased by a customer at a point of sale;
said first computer further configured to evaluate the rebate claim using at least part of said rebate-claim-information;
said first computer further configured to initiate a transfer of rebate-claim-status information to at least one of (a) said first remote computer, and (b) a second remote computer located at the point of sale;
wherein said transfer of rebate-claim-status information occurs while said customer is at said point of sale.

19. An electronic rebate system as in claim 18, wherein at least part of said rebate-claim-information is retrieved from an electronic tag associated with said product.

20. An electronic rebate processing system as in claim 19, wherein said electronic tag is a RFID smart tag.

21. An electronic rebate processing system as in claim 18, wherein said first computer is one of a manufacturer central computer and a third party computer.

22. An electronic rebate processing system as in claim 18, wherein said second remote computer is a portable customer computer in communication with at least one of said first computer and said first remote computer via a wireless communication connection.

23. An electronic rebate processing system as in claim 18, wherein said rebate-claim-information comprises at least one member from the group consisting of: (a) customer name; (b) customer's financial institution tracking number; (c) customer's account number at customer's financial institution; (d) customer's mailing address; (e) customer's e-mail address; (f) customer's phone number; (g) customer's credit card number; (h) customer's debit card number; (i) a pin code; (j) an authorization code; (k) customer's electronic signature; (l) product model number; (m) product serial number; (n) rebate promotion code; (o) product name; (p) an electronic address; (q) proof-of-purchase code; (r) date of purchase; (s) time of purchase; (t) product identification code; (u) product information; (v) retailer name; (w) retailer location; (x) retailer identification code; and (y) transaction code.

24. An electronic rebate processing system as in claim 23, wherein said first computer is further configured to initiate an electronic fund transfer from a first bank account into a second bank account in the amount of the rebate.

25. An electronic rebate processing system as in claim 24, wherein said electronic fund transfer is an automated clearing house transfer.

26. An electronic rebate processing system as in claim 23, wherein said first computer is configured to transmit an electronic mail message to a predefined electronic mail address wherein said electronic mail message contains at least part of said rebate-claim-status information.

27. A method for electronically making a rebate claim, said method comprising:
providing at least one electronic reading device configured to retrieve product-information stored in an electronic tag associated with a purchased product;
configuring a first computer to communicate with said electronic reading device to retrieve at least part of said product-information stored in at least one electronic tag associated with a product being purchased by a customer at a point of sale thereby acquiring product-identification-information;
configuring said first computer to acquire rebate-claim-information using at least part of said product-identification-information;
configuring said first computer to initiate a data transfer of said rebate-claim-information to a second computer.

28. A method for electronically making a rebate claim as in claim 27, wherein said electronic tag device is an RFID smart tag.

29. A method for electronically making a rebate claim as in claim 27, wherein said electronic reading device is an RFID STR device.

30. A method for electronically making a rebate claim as in claim 27, wherein said first computer is a retailer central computer.

31. A method for electronically making a rebate claim as in claim 27, wherein said second computer is one of a manufacturer central computer and a third party computer.

32. A method for electronically making a rebate claim as in claim 27, wherein said product-identification-information comprises at least one member from the group consisting of: (a) product model number; (b) product serial number; (c) rebate promotion code; (d) product name; (e) identification code; (f) proof-of-purchase code; (g) an electronic address; and (f) a URL link.

33. A method for electronically making a rebate claim as in claim 27, wherein said rebate-claim-information comprises at least one member from the group consisting of: (a) customer name; (b) a financial institution tracking number; (c) an account number at a financial institution; (d) customer's mailing address; (e) customer's e-mail address; (f) customer's phone number; (g) customer's credit card number; (h) customer's debit card number; (i) a pin code; (j) an authorization code; (k) customer's electronic signature; (l) product model number; (m) product serial number; (n) rebate promotion code; (o) product name; (p) an electronic address; (q) proof-of-purchase code; (r) date of purchase; (s) time of purchase; (t) product identification code; (u) product information; (v) retailer name; (w) retailer location; (x) retailer identification code; and (y) transaction code.

34. A method for electronically making a rebate claim as in claim 27, wherein said first computer is further configured to receive rebate status information.

35. A method for electronically making a rebate claim as in claim 34, wherein said rebate status information comprises at least one member from the group consisting of: (a) rebate accepted notice; (b) rebate denied notice; (c) rebate denied code; (d) rebate reference code; (e) EFT transaction code; (f) e-mail notification notice; and (h) rebate check number.

36. A method for electronically making a rebate claim as in claim 34, wherein said first computer is further configured to generate at least one of (a) rebate status documentation and (b) a receipt, wherein said rebated status documentation and said receipt comprise at least part of said rebate status information and is given to said customer at said point of sale.

37. A method for electronically making a rebate claim, said method comprising:
providing at least one electronic reading device configured to retrieve information from at lease one electronic tag associated with a product being purchased by a customer at a point of sale;
configuring a first computer, communicating with said electronic reading device, to retrieve rebate-claim-tag-information from at least one electronic tag associated with said product;
configuring said first computer to acquire rebate-claim-retailer-information;
configuring said first computer to acquire rebate-claim-customer-information;
initiating a data transfer to a second computer wherein said data transfer comprises at least one of said rebate-claim-tag-information, said rebate-claim-retailer-information and said rebate-claim-customer-information; and
wherein said transfer is initiated while said customer is at said point of sale.

38. A method for electronically making a rebate claim as in claim 37, wherein said rebate-claim-tag-information is at least one member from the group consisting of: (a) product model number; (b) product serial number; (c) rebate promotion code; (d) product name; (e) an electronic address; and (f) proof-of-purchase code.

39. A method for electronically making a rebate claim as in claim 43, wherein said rebate-claim-customer-information is at least one member from the group consisting of: (a) customer name; (b) a financial institution tracking number; (c) an account number at a financial institution; (d) customer's mailing address; (e) customer's e-mail address; (f) customer's phone number; (g) customer's credit card number; (h) customer's debit card number; (i) a pin code; (j) an authorization code; (k) customer's electronic signature; and (l) an electronic address.

40. A method for electronically making a rebate claim as in claim 37, wherein said rebate-claim-retailer-information is at least one member from the group consisting of: (a) product model number; (b) product serial number; (c) rebate promotion code; (d) product name; (e) an electronic address; and (f) proof-of-purchase code; (g) date of purchase; (h) time of purchase; (i) retailer name; (j) retailer location; (k) retailer identification code; and (l) transaction code.

41. A method for electronically making a rebate claim as in claim 37, wherein said electronic tag device is an RFID smart tag and wherein said electronic reading device is an RFID STR device.

42. A method for electronically making a rebate claim as in claim 37, wherein said second computer is one of a manufacturer central computer and a rebate processing center central computer.

43. A method for electronically making a rebate claim as in claim 37, wherein said first computer is further configured to receive rebate status information.

44. A method for electronically making a rebate claim as in claim 43, wherein said first computer is further configured to generate at least one of (a) rebate status documentation and (b) a receipt, wherein said rebated status documentation and said receipt comprise at least part of said rebate status information and are given to said customer at said point of sale.

45. A method for electronically making a rebate claim as in claim 43, wherein said rebate status information comprises at least one member from the group consisting of: (a) rebate accepted notice; (b) rebate denied notice; (c) rebate denied code; (d) rebate reference code; (e) EFT transaction code; (f) e-mail notification notice; and (h) rebate check number.

46. A method for electronically making a rebate claim, said method comprising:
retrieving information from an electronic tag associated with a product being purchased by a customer at a point of sale;
acquiring rebate-claim-information;
initiating the transfer of said rebate-claim-information to a rebate-claim-processing-computer while said customer is at said point of sale.

47. A method for electronically making a rebate claim as in claim 46, wherein said electronic tag device is an RFID smart tag and the step of retrieving information from an electronic tag is accomplished using an RFID STR device.

48. A method for electronically making a rebate claim as in claim 46, wherein said rebate-claim-processing-computer is one of a manufacturer central computer and a rebate processing center central computer.

49. A method for electronically making a rebate claim as in claim 46, further comprising the step of receiving rebate status information.

50. A method for electronically making a rebate claim as in claim 46 further comprising the step of generating at least one of (a) rebate status documentation and (b) a receipt, wherein said rebated status documentation and said receipt comprise at least part of said rebate status information and are given to said customer at said point of sale.

51. A method for electronically processing a rebate claim, said method comprising:
associating at least one electronic tag device with products, wherein each distinct product is associated with at least one electronic tag, and wherein said electronic tag is configured to store product-information;
receiving a rebate claim comprising rebate-claim-information for a product being purchased by a customer at a point of sale;
evaluating the validity of said rebate claim using at least part of said rebate-claim-information; and
transmitting rebate-claim-status information to a computing device at the point of sale wherein at least part of said rebate-claim-status information is presented to said customer at said point of sale.

52. A method for electronically processing a rebate request as in claim 51, wherein said electronic tag device is an RFID smart tag.

53. A method for electronically processing a rebate request as in claim 51, wherein said rebate-claim-status information is transmitted to a hand held computing device at the point of sale.

54. A method for electronically processing a rebate request as in claim 51, further comprising the step of transmitting an electronic mail message to a predefined electronic mail address wherein said electronic mail message contains at least part of said rebate-claim-status information.

55. A method for electronically processing a rebate request as in claim 51, further comprising the step of initiating an electronic fund transfer to a predefined bank account upon validating the rebate claim, wherein said electronic fun transfer is in the amount of the rebate.

56. A method for electronically processing a rebate request as in claim 55, wherein said electronic fund transfer is an automated clearing house transfer.

57. A method for electronically processing a rebate request as in claim 55, wherein the status of said electronic fund transfer transaction is indicated on a receipt given to the customer at the point of sale.

58. A method for electronically processing a rebate claim, said method comprising:
receiving a rebate claim comprising rebate-claim-information for a product being purchased by a customer at a point of sale;
evaluating the validity of the rebate claim using at least part of said rebate-claim-information; and
transmitting rebate-claim-status information to a computing device at the point of sale while said customer is at said point of sale.

59. A method for electronically processing a rebate request as in claim 58, further including the step of associating at least one electronic tag device with products, wherein each distinct product is associated with at least one electronic tag, and wherein said electronic tag is configured to store product-information;

60. A method for electronically processing a rebate request as in claim 59, wherein said electronic tag device is an RFID smart tag.

61. A method for electronically processing a rebate request as in claim 59, wherein said rebate claim is evaluated by at least one of a manufacturer central computer and a rebate processing center central computer.

62. A method for electronically processing a rebate request as in claim 59, further comprising the step of transmitting an electronic mail message to a predefined electronic mail address wherein said electronic mail message contains at least part of said rebate-claim-status information.

63. A method for electronically processing a rebate request as in claim 59, further comprising the step of initiating an electronic fund transfer in the amount of the rebated to a predefined bank account upon validating the rebate claim.

64. A method for electronically processing a rebate request as in claim 63, wherein said electronic fund transfer is an automated clearing house transfer.

65. A method for electronically processing a rebate request as in claim 64, wherein a message indicating the status of said electronic fund transfer is indicated on a receipt given to the customer at the time of purchase.
